(19) United States
(12) Patent Application Publication
(10) Pub. No.: US 2006/0277193 A1
(43) Pub. Date: Dec. 7, 2006

(54) System and method for internet-based financial analysis and data processing for the creation of financial reports

(76) Inventor: Craig T. Moncreiff, San Diego, CA (US)

Correspondence Address: PETER K HAHN;LUCE, FORWARD, HAMILTON, SCRIPPS, LLP., 600 WEST BROADWAY, SUITE 2600, SAN DIEGO, CA, 92101, US

(21) Appl. No.: 11/144,986

(22) Filed: Jun. 2, 2005

(51) Int. Cl. G06F 17/30

(52) U.S. Cl. 707/10

(57) ABSTRACT

Systems and methods are provided for Internet-based financial analysis and data processing for the creation of a financial report, including: assembling data inputs and database inputs over the Internet; analyzing and processing the data inputs and database inputs; and creating an SEC-compliant financial report. The system and method may be implemented using a computer software program that is based on logic routines that evaluate the data and database inputs, and determine which information to incorporate into the report.

### FIELD OF THE INVENTION

This invention relates to corporate financial analysis and reporting, and more particularly to a system and method for Internet-based financial analysis and data processing for the creation of financial reports such as corporate annual reports.

### BACKGROUND OF THE INVENTION

Businesses generally spend large sums of money creating, printing and distributing corporate annual reports and other financial documents to shareholders and investment advisors. These reports may be created using software that organizes data relating to the financial performance of a business, such that the data may be displayed on a computer monitor or printed out on paper.

There exist a number of software-based corporate report systems on the market today. For example, one such software application is provided by ValusSource (Colorado Springs, Colo.) (www.valusourcesoftware.com). The software application comprises an expert business valuation system for accountants for installation on a computer hard drive. The software application prompts the user to input various company data, step through a business appraisal, download data, and generate and edit a narrative report. However, this system suffers from a number of drawbacks.

One drawback is that the software application does not produce an “Annual Report” for a business. More particularly, the system does not provide an Annual Report that follows the SEC 10K and 10K SB, which includes a Description of the Business, Property, Market for Equity, Management Discussion and Analysis, Financial Statements, Disagreements, Related Transactions, Compliance issues, and other information. Nor does this system focus on a period of time, (i.e. the last year), but rather focuses on a point in time (i.e., the appraisal date). Another drawback is that the system is not an Internet-based system that integrates information from various on-line databases for the creation of financial reports. Without on-line access, the service provider cannot offer additional important services such as professional editing of the report. A further drawback is that the software application does not permit multiple users (e.g., a business manager and an adviser) to work on a single report at the same time. Nor does this system intend to have multiple users as appraisals are conducted typically by a single “appraiser”. Yet another drawback is that the system does not provide a fully integrated on-line narrative report editor. Another drawback is that the system offers add-on databases that only include multiple industries. Finally, the ValuSource system requires significant training and an accounting background, as it is not intended for corporate managers but for professional accounting and valuation experts.

Another prior art software-based corporate report system is described in U.S. Pat. No. 5,819,271. This reference teaches a computer-based system for the electronic distribution of corporate information comprising a central repository server coupled to one or more remote contributor workstations, which may be used by brokerage and investment banking firms to submit investment reports to the repository server. The central repository server is coupled to one or more remote corporation workstations, which are used by corporations to submit corporation information to the repository server. The repository server allows investors to request lists of reports and corporate information that fit selected criteria. However, this system also suffers from a number of drawbacks.

One drawback is that the system does not allow advisers to generate reports by integrating text, analysis and outside databases in a structured and controlled on-line environment, wherein basic company information, detailed financial statements and strategic plans/goals are inputted into the system by an adviser, and wherein the system examines the data, analyzes the results and automatically creates one or more integrated reports. Another drawback is that the system does not allow multiple users to collaborate on a single report.

In view of the above drawbacks, there exists a need for a system and method for Internet-based financial analysis and data processing for the creation of financial reports such as corporate annual reports.

There further exists a need for an Internet-based system and method for incorporating financial data, user inputs, and on-line databases for the creation of financial reports.

Additionally, there exists a need for an Internet-based system and method for automatically creating comprehensive narrative reports based on logic routines that analyze financial data and user inputs.

There also exists a need for an Internet-based system and method including a software application that produces an Annual Report that follows the SEC 10K and 10K SB.

In addition, there exists a need for an Internet-based system for the creation of financial reports that integrates information from various on-line databases.

There further exists a need for an Internet-based system and method for the creation of financial reports including a fully integrated narrative report editor.

There additionally exists a need for a method for the creation of financial reports that permits users such as business managers to input financial data directly into an Internet-based financial analysis system.

In addition, there exists a need for an Internet-based system and method for the creation of financial reports that allows control of users' ability to access, view, edit and perform financial analyses.

There further exists a need for an Internet-based system and method for the creation of financial reports including the collection of private comparable business transactions, such as sales transaction details, by purchasing the transaction data from brokers.

There also exists a need for an Internet-based system and method for the creation of financial reports including collecting and compiling comparable business transactions, and then selling the compiled transaction data and/or incorporating the data into a database for additional database inputs.

### SUMMARY OF THE INVENTION

In view of the foregoing, it is an object of the present invention to provide a system and method for Internet-based financial analysis and data processing for the creation of financial reports such as corporate annual reports.

It is a further object of the present invention to provide an Internet-based system and method for incorporating financial data, user inputs and on-line databases, for the creation of financial reports.

It is another object of the present invention to provide an Internet-based system and method for automatically creating comprehensive narrative reports based on logic routines that analyze financial data.

There also exists a need for an Internet-based system and method including a software application that produces an Annual Report that follows the SEC 10K and 10K SB.

It is a further object of the present invention to provide an Internet-based system for the creation of financial reports that integrates information from various on-line databases.

It is another object of the present invention to provide an Internet-based system and method for the creation of financial reports including a fully integrated narrative report editor.

It is an additional object of the present invention to provide a method for the creation of financial reports that permits users such as business managers to input financial data directly into an Internet-based financial analysis system.

It is a further object of the present invention to provide an Internet-based system and method for the creation of financial reports that permits multiple users, such as a business manager and an adviser, to work on a single report at the same time.

It is an additional object of the present invention to provide an Internet-based system and method for the creation of financial reports that controls users' ability to access, view, edit and perform financial analyses.

It is another object of the present invention to provide an Internet-based system and method for the creation of financial reports including the collection of comparable business transactions, such as sales transactions, by purchasing or otherwise acquiring the transaction data from brokers.

It is yet another object of the present invention to provide an Internet-based system and method for the creation of financial reports including collecting and compiling comparable business transactions, and then selling the compiled transaction data.

One aspect of the present invention involves a system and method for Internet-based financial analysis and data processing for the creation of a financial report, including: assembling data inputs and database inputs over the Internet; analyzing and processing the data inputs and database inputs; and creating an SEC-compliant financial report. The system and method may be implemented using a computer software program that is based on logic routines that evaluate the data and database inputs, and determine which information to incorporate into the report.

According to a preferred implementation of the invention, each data input is designed to address a different department within a business. The data inputs may include a Management's Directive input, an Accounting/Results input, a Core Operations input, a Sales/Marketing input, a Legal Counsel input and an Overall Message input. The financial report comprises a plurality of sections including a Description of the Business section, a Property section, a Market for Equity section, a Management Discussion and Analysis section, a Financial Statements section, a Disagreements section, a Related Transactions section, and a Compliance Issues section.

According to some embodiments of the invention, the financial report comprises an Annual Report that follows the format of the SEC 10K and 10K SB. Advantageously, the financial report may be analyzed and edited by multiple users simultaneously. Additional aspects of the invention involve the use of an on-line, fully integrated narrative report editor, and the ability to create an industry-specific on-line report that only provides data for a selected company and industry. A further embodiment allows users to create their own inputs, boilerplate text, analysis and logical operators to create their own customized reporting system.

### BRIEF DESCRIPTION OF THE DRAWINGS

These and other features and advantages of the invention will become more apparent upon reading the following detailed description and upon reference to the accompanying drawings.

FIG. 1 is a schematic diagram of a preferred system for Internet-based financial analysis and data processing for the creation of financial reports in accordance with the principles of the present invention

FIG. 2 is a schematic diagram of a Management Reports homepage of a preferred website of the invention;

FIG. 3 is a schematic diagram of a Start, Edit or View Your Report web page of the preferred website of the invention;

FIG. 4 is a schematic diagram of a Create a New Account web page of the preferred website of the invention;

FIG. 5 is a schematic diagram of an Account Manager web page of the preferred website of the invention;

FIG. 6 is a schematic diagram of a Start a New Report web page of the preferred website of the invention;

FIG. 7 is a schematic diagram of a User Access Control web page of the preferred website of the invention;

FIG. 8 is a schematic diagram of an Annual Reports Plus—Data Input web page of the preferred website of the invention;

FIG. 9 is a schematic diagram of a Company Data Input web page of the preferred website of the invention; and

FIG. 10 is a schematic diagram of a Sample Report web page of the preferred website of the invention.

### DETAILED DESCRIPTION

In the following paragraphs, the present invention will be described in detail by way of example with reference to the attached drawings. Throughout this description, the preferred embodiment and examples shown should be considered as exemplars, rather than as limitations on the present invention. As used herein, the “present invention” refers to any one of the embodiments of the invention described herein, and any equivalents. Furthermore, reference to various feature(s) of the “present invention” throughout this document does not mean that all claimed embodiments or methods must include the referenced feature(s).

The present invention provides a system and method for Internet-based financial analysis and data processing for the creation of financial reports such as corporate annual reports. The system incorporates financial data, boilerplate text, user financial and narrative inputs, and on-line databases over the Internet in order to create a complete business analysis and SEC-compliant Annual Report. Such Annual Reports are directed to the performance of a company for the past year, and are intended for external use. The system and method preferably are implemented using one or more computer software programs comprising machine readable or interpretable instructions for the analysis of data and the creation of financial reports. The software program is based on logic routines that evaluate data, text, numbers, and values calculated therefrom, and determine which information to incorporate into the report.

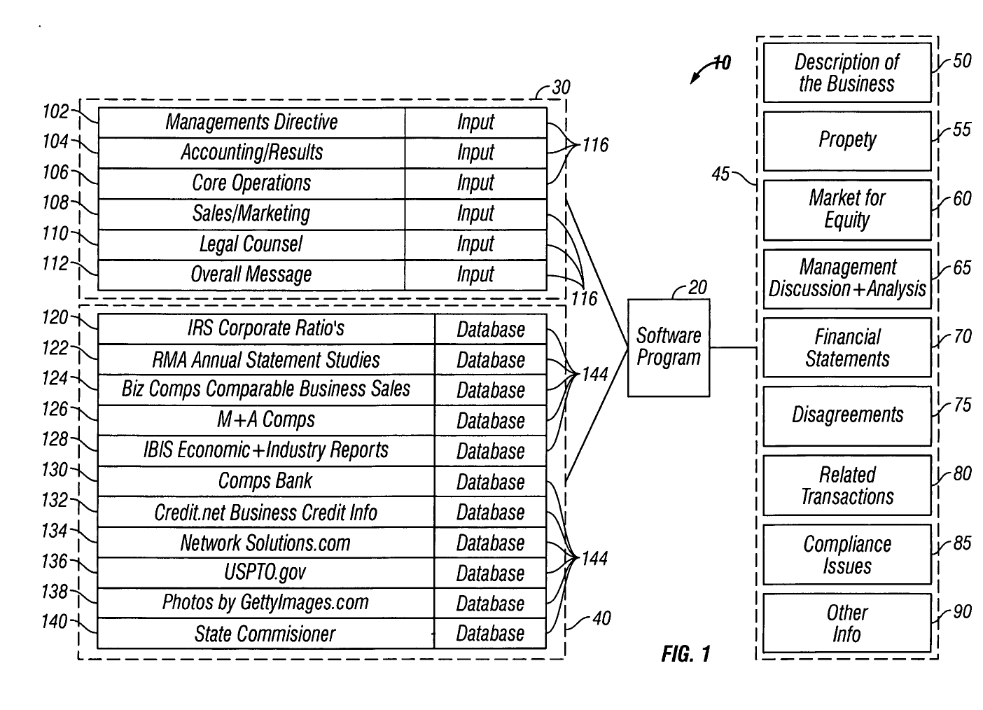

Referring to FIG. 1, a preferred system 10 for Internet-based financial analysis and data processing for the creation of financial reports in accordance with the principles of the present invention will now be described. The system comprises software program 20 for analyzing and processing data inputs 30 and database inputs 40 for the creation of financial report 45. In the illustrated embodiment, financial report 45 includes a plurality of sections 50, 55, 60, 65, 70, 75, 80, 85, 90 that combine to form a comprehensive financial reporting system. In the illustrated embodiment, data inputs 30 include: Management's Directive 102; Accounting/Results 104; Core Operations 106; Sales/Marketing 108; Legal Counsel 110; and Overall Message 112. Additional data inputs 116 are provided for other information and reports.

With further reference to FIG. 1, database inputs 40 comprise: IRS Corporate Ratios 120; RMA Annual Statement Studies 122; BizComps Comparable Business Sales 124; M&A Comps 126; IBIS Economic and Industry Reports 128; CompsBank 130; Credit.net Business Credit Info 132; Network Solutions.com 134; USPTO.gov 136; Photos by GettyImages.com 138; and State Commissioner 140. Additional database inputs 144 are provided for other databases. As would be appreciate by those of skill in the art, additional data and database inputs may be incorporated into the system of FIG. 1 without departing from the scope of the invention.

In accordance with the principles of the invention, each data input may be designed to address a different department within a business. The information contained in each data input may comprise number, label, checkbox and/or narrative information that is entered by an authorized user such as a particular corporate officer or advisor. Particularly, the authorized user enters the appropriate information into various input fields, for example using a word processing editor format. The data inputs may be completed and entered into the system over the Internet by an authorized user from a remote location.

The Management's Directive 102 data input is designed to be completed and entered into the system (e.g., over the Internet from a remote location) by the President or Chief Executive Officer (CEO) of the company. By way of example, Management's Directive 102 may include the following information: (1) Letter from the President; (2) Selection of Overall Theme; and (3) Final Review. Accounting/Results 104 is designed to be completed and entered into the system by the Chief Financial Officer (CFO) or by an Auditor. The Accounting/Results data input may include the following data: (1) Management Discussion and Analysis; (2) Financial Statements; (3) Market for Common Equity; (4) Executive Compensation; (5) Code of Ethics; and (6) Related Transactions. Core Operations 106 is designed to be completed and entered into the system by the Chief Operating Officer (COO). As an example, Core Operations 106 may include: (1) Discussion of Operations; (2) Personnel; (3) Competition; (4) Suppliers; and (5) New Initiatives.

Sales/Marketing 108 is designed to be completed and entered into the system by an officer such as the Vice President of Marketing. By way of example, this data input may comprise: (1) Marketing Plan; (2) Sales Methodologies; and (3) Customers. Legal Counsel 110 is designed to be completed and entered into the system by corporate counsel. The legal counsel input may include the following information: (1) Legal Proceedings; (2) Discussion of Intellectual Property; (3) Government Regulations; and (4) Compliance Filings. Overall Message 112 may be completed and entered into the system by Investor Relations and/or a Communications Director. As an example, overall message 112 may comprise the following data: (1) Description of Business & Property; (2) Officer Listings & Contact Information; (3) Overall Look & Feel; and (4) Report Editing.

As would be understood by one of ordinary skill in the art, the specific examples set forth hereinabove regarding the type of information contained within each data input are for illustrative purposes only, and the type of information contained within each data input may be changed without departing from the scope of the invention. Additionally, it will be apparent to those of skill in the art that the particular corporate officers and advisors that are set forth hereinabove as authorized users may be changed without departing from the scope of the invention

Databases 40 comprise both public and proprietary databases, including: (1) IRS Corporate Ratios 120, published by the Internal Revenue Service; (2) RMA Annual Statement Studies 122, published by the Risk Management Association; (3) BizComps Comparable Business Sales 124, published by Jack Sanders; (4) M&A Comps 126, published by Done Deals of the World M&A Network; (5) IBIS Economic and Industry Reports 128, published by IBIS World; (6) CompsBank 130, published by IVP, Inc; (7) Credit.net Business Credit Info 132, published by InfoUSA.com; (8) Network Solutions.com 134; (9) USPTO.gov 136; (10) Photos by GettyImages.com 138; (11) State Commissioner 140; and other databases 144. As would be understood by one of ordinary skill in the art, different databases then those set forth hereinabove may be employed by the system without departing from the scope of the invention.

According to the preferred embodiment of the invention, financial report 45 comprises a plurality of sections 50, 55, 60, 65, 70, 75, 80, 85, 90, for example in the form of a plurality of text boxes, each text box containing a section of the financial report 45. Sections 50, 55, 60, 65, 70, 75, 80, 85, 90 may comprise a first draft of financial report 45 in its entirety. More particularly, each text box containing a section may be edited by an authorized user for accuracy and completeness. According to an aspect of the invention, the editing of financial report 45 is reviewed and approved by the service provider. Additionally, the service provider may perform a desk-top publishing step, wherein the output is reviewed as a .pdf file so that the authorized user may view the entire document prior to printing and shipping. According to additional embodiments of the invention, the financial report may be produced as a formal glossy report that can be distributed to investors, potential buyers, vendors, employees and other external interested parties.

With further reference to FIG. 1, according to a preferred implementation of the invention, financial report 45 comprises an Annual Report that follows the format of the SEC 10K and 10K SB. Specifically, the Annual Report comprises the following sections: (1) Description of the Business 50; (2) Property 55; (3) Market for Equity 60; (4) Management Discussion and Analysis 65; (5) Financial Statements 70; (6) Disagreements 75; (7) Related Transactions 80; (8) Compliance Issues 85; and (9) Other Information 90. The invention also provides a standardized analysis and narrative reporting tool that features automated financial analysis, industry comparisons, credit reports, goal setting and goal seeking.

The software program of the present invention is designed to create an Annual Report that may be employed by private business owners to provide a summary of business performance and standing over the latest current year. By contrast, conventional Annual Reports are provided almost exclusively for public and not-for-profit companies and are exclusively compiled manually. Advantageously, the software program is also designed to increase non-compliance reporting and analysis for enterprise size companies. By providing a short form Sarbanes-Oxley summary form, an automated credit check, various financial analyses, and intellectual property reviews, the system of the invention provides a full inspection of business areas that are not reviewed in a standard financial audit.

According to an aspect of the invention, the preferred system of the invention allows multiple users to perform analysis and edit a single report simultaneously, thereby significantly reducing the processing time and efficiency of the reporting process. The system permits a collaborative process wherein CFO's, CEO's, accountants, marketing managers, investor relations representatives, various artists and communications directors, and other authorized users to work on the same Annual Report at the same time and/or remotely (e.g., over the Internet). By contrast, conventional systems reside on a single hard drive or local area network (LAN) and are only accessible by those on the same computer or on the same network. The system of the present invention is much faster, more cost-effective and less cumbersome than conventional systems.

Since the preferred system of the invention is an on-line system, the service provider has constant, real time access to the analysis and report. Advantageously, this real time access allows the service provider to offer additional services such as: (1) professional editing of the report; (2) required desk top publishing of the Annual Report; and (3) printing for shipment of the Annual Report. A further advantage of providing an on-line system is that there is no limit to the number of databases that from which to draw data into the analysis and report. Additionally, the on-line system allows users to receive access to the most current information in real time. Another advantage of providing an on-line system is that new users can get started immediately. Moreover, the on-line reporting service can be initiated by the customer and the analysis performed solely be the customer, thereby eliminating sales and shipping costs. In this manner, both the service provider and the user can save time and money using a more productive and efficient system.

An additional advantage of providing an on-line system is that the service provider can use the various inputs and analyses to generate other business reports, such as including: (1) lending documents; (2) buy/sell documents; (3) benchmark appraisals; (4) business inspections and (5) efficiency reports. Advantageously, the software program of the invention is based on logic routines that allow it to “learn” about a company as the inputs are being entered and to anticipate and dynamically forecast future inputs. For example, if an authorized user identifies the company as a Sub-Chapter S corporation, the software program automatically determines that: (1) the end of the fiscal year end will be the end of the calendar year; and (2) that there will only be one class of stock.

Another aspect of the present invention involves the ability of the service provider to automatically update all databases, and manage all analysis and reporting tools, thereby potentially obviating the need for an IT manager. A major drawback of conventional systems concerns the complications that may be caused by multiple users installing and storing systems disks, report writer disks, and disks for multiple databases. The Internet-based system of the invention solves the management problem on the user's end as well as the significant and costly technical support issues on the provider side.

A further aspect of the invention involves the creation of a report using an on-line, fully integrated narrative report editor. The on-line editor allows the system to automatically integrate boilerplate text and coded numbers with the analysis, and also provides robust word processing capabilities. The system further provides an ability to set logical operand that determine which text and financial numbers to integrate into the report based on the user inputs. According to some embodiments of the invention, the system may be used to merge on-line data with on-line narrative reports.

An additional aspect of the invention involves the ability to create an industry-specific on-line report that provides users with only the data that they need for a chosen company and industry. This is a significant advantage over conventional systems, wherein the manufacturer must ship databases that include all industries. A further aspect of the present invention involves the use of an automatic database call out. Specifically, when an industry classification is selected, the software program performs a database call out to the Internet to determine the best format for the selected industry for financial statement inputs.

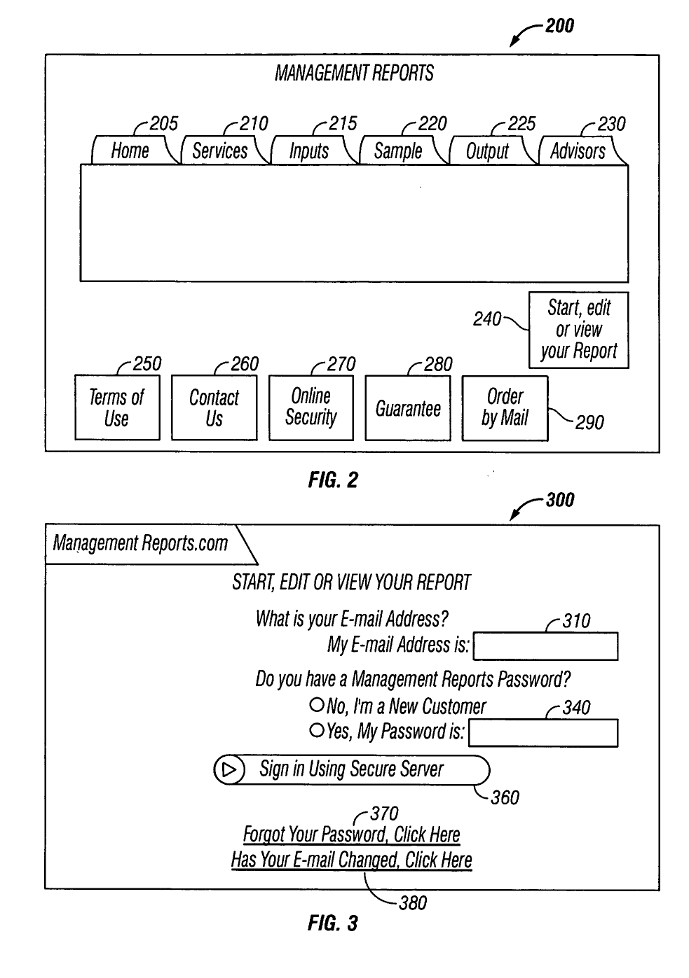

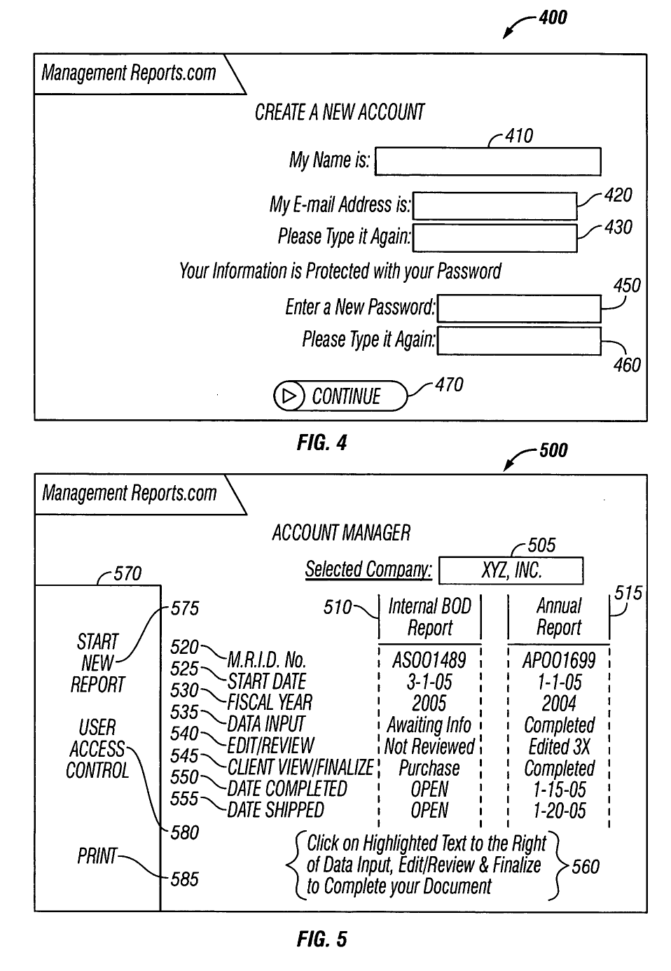

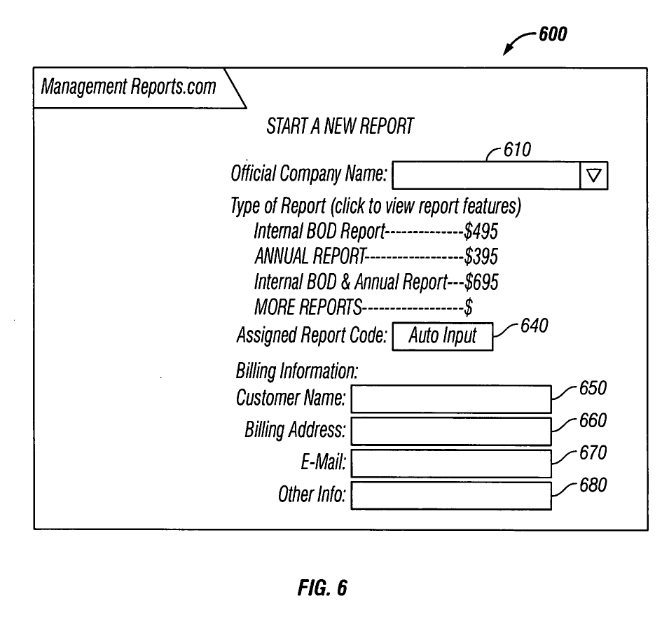

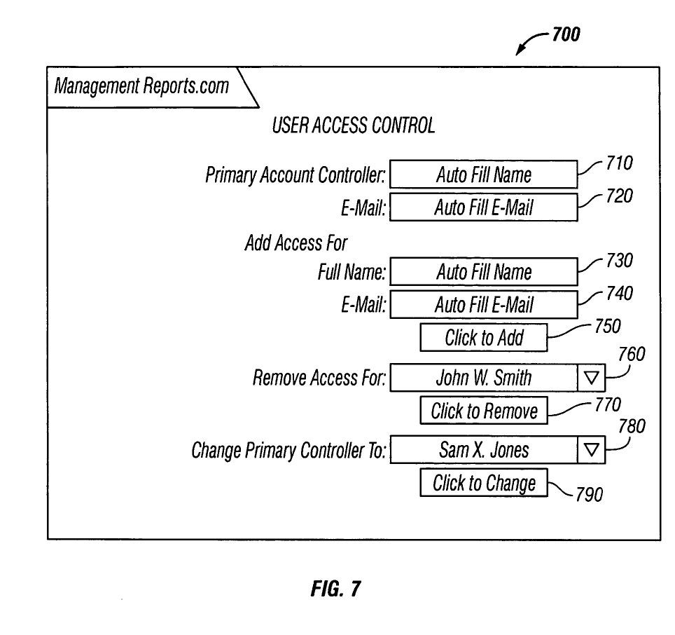

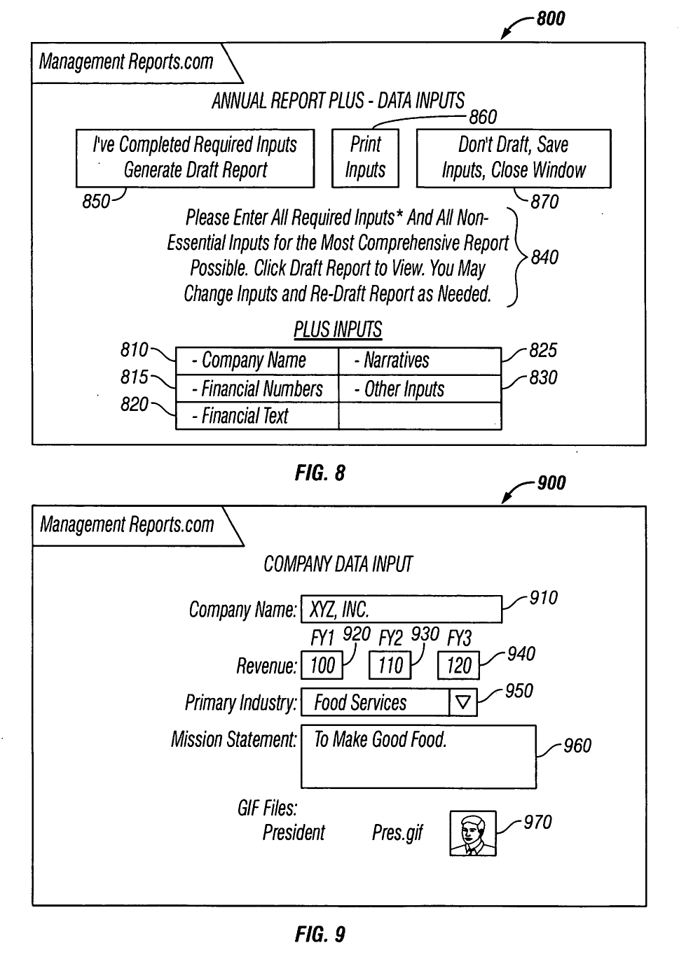

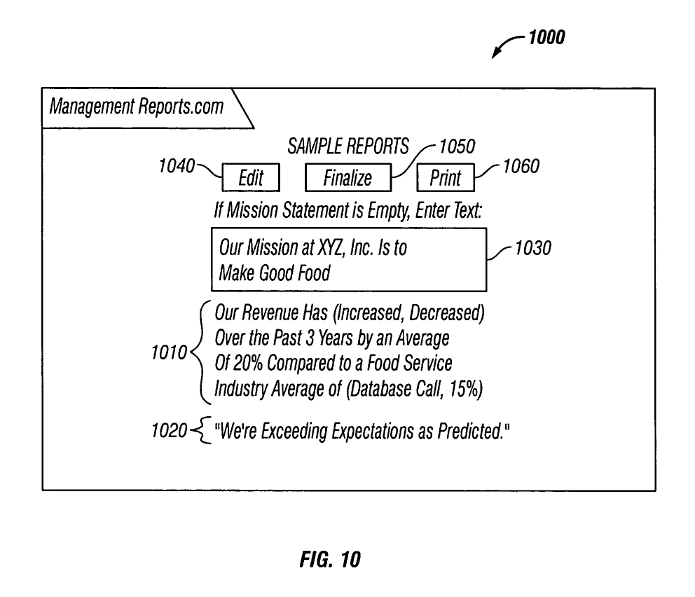

FIGS. 2-10 illustrate web pages 200, 300, 400, 500, 600, 700, 800, 900, 1000 of an exemplary Management Reports website. Specifically, FIG. 2 depicts the Management Reports homepage 200, FIG. 3 depicts the Start, Edit or View Your Report web page 300, FIG. 4 depicts the Create a New Account web page 400, FIG. 5 depicts the Account Manager web page 500, FIG. 6 depicts the Start a New Report web page 600, FIG. 7 depicts the User Access Control web page 700, FIG. 8 depicts the Annual Reports Plus—Data Input web page 800, FIG. 9 depicts the Company Data Input web page 900, and FIG. 10 depicts the Sample Report web page 1000.

Referring to FIG. 2, Management Reports homepage 200 provides strategic planning and corporate financial reporting for business owners, directors, investors and advisors. Management Reports homepage 200 provides a plurality of tab options including: (1) Home 205; (2) Services 210; (3) Inputs 215; (4) Sample 220; (5) Output 225; and (6) Advisors 230. In addition, start button 240 is provided for starting, editing or viewing a report. In the illustrated embodiment, Management Reports homepage 200 further comprises a plurality of links, including: (1) Terms of Use 250; (2) Contact Us 260; (3) Online Security 270; (4) Guarantee 280; and (5) Order By Mail 290.

With further reference to FIG. 2, the tab options for Home 205, Services 210, Inputs 215, Output 225 and Advisors 230 are text pages provided with links and graphics, whereas the Sample tab option 220 is a text page or .pdf file of a sample report. The links for Terms of Use 250, Online Security 270, Guarantee 280 and Order By Mail 290 are links to text pages with links and graphics, whereas Contact Us 260 is a text page provided with an email link. According to some embodiments of the invention, Management Reports homepage 200 may further include graphic animation including various advertisements, a secure server logo, and text link to terms of service.

FIG. 3 depicts the Start, Edit or View Your Report web page 300 of the Management Reports website, which may be opened by clicking on start button 240. Once web page 300 is opened, an authorized user is prompted to enter an email address in box 310. The user is then prompted to either check circle 320 indicating that she is a new customer, or to check circle 330 indicating that she already has an existing Management Reports password. Existing authorized users are prompted to enter the appropriate password within box 340, whereas new users are directed to Create a New Account web page 400 to set up a new account, as discussed hereinbelow with respect to FIG. 4. Start, Edit or View Your Report web page 300 also provides: (1) link 360 for signing in using a secure server; (2) link 370 for users that have forgotten their password; and (3) link 380 for users that have changed their email address.

Referring to FIG. 4, new users are prompted to enter require information on Create a New Account web page 400. Specifically, box 410 is provided for the new user's name, box 420 is provided for the new user's email address and box 430 is provided for the new user's password. Additionally, box 450 is provided for retyping the new user's email address, and box 460 is provided for retyping the new user's password. The new user is prompted to click box 470 after entering the appropriate information.

Referring to FIG. 5, Account Manager web page 500 for a selected company is accessible by one or more authorized users. In the illustrated embodiment, the authorized user has chosen XYZ, Inc as the selected company, for example by typing in the company name in box 505, or by choosing the appropriate name from a conventional drop-down menu. Account Manager page 500 includes an Internal Board of Directors column 510 and an Annual Report column 515, wherein each column includes row entries for: (1) Management Reports Identification Number 520 (“M.R. I.D. No.”); (2) Start Date 525; (3) Fiscal Year 530; (4) Data Input 535; (5) Edit/Review 540; (6) Client View/Finalize 545; (7) Date Completed 550; and (8) Shipped Date 555. As would be appreciated by those of ordinary skill in the art, additional columns for other types of financial reports may be provided without departing from the scope of the present invention. Of course, additional row entries may also be provided (e.g., Administrative/Finalize, to allow a financial administrator to make changes to a report) without departing from the scope of the present invention. A time limit may be provided for the financial administrator to complete the review of a particular report.

Account Manger page 500 is adapted to display all reports for the selected company that the user has access to or all companies that an advisor has access to. The start date for a report comprises the most recent start date for that particular report. In the illustrated embodiment, the start date for the fiscal year 2005 Internal Board of Directors is Mar. 1, 2005, whereas the start date for the fiscal year 2004 Annual Report is Jan. 1, 2005. In addition, the Internal Board of Directors column 510 indicates that the system is awaiting input regarding the 2005 report, which has not yet been created or reviewed. On the other hand, with respect to the 2004 Annual Report: (1) data input has been completed; (2) the report has been edited three times; (3) the report was completed on Jan. 15, 2005; and (4) the report was shipped on Jan. 20, 2005.

According to a preferred embodiment of the invention, the data entries for Data Input 535 Edit/Review 540 Client View/Finalize 545 are accessible in a predetermined and systematic order. Initially, only Data Input 535 is selectable (e.g., clickable) for entering company data. Once the appropriate data has been entered, Edit/Review 540 becomes selectable so that the user may review and edit the report. Once the user has reviewed and edited the report, the Client View/Finalize 545 may be selected to purchase the report. Text 560 is provided indicating that a user should click on the highlighted text of the appropriate data entry to complete a document.

With further reference to FIG. 5, once the user has selected a company, text box 570 appears with links to Start a New Report 575, User Control Access 580 and Print 585. Of course, as would be understood to one of ordinary skill in the art, various additional links may be provided without departing from the scope of the present invention. According to some embodiments of the invention, Account Manager page 500 keeps track of certain customer company statistics including: (1) percentage of potential customers that start to register, but do not finish; (2) percentage of customers that upgrade from Annual Report Standard to annual Report Plus; (3) percentage of customers that renew their subscription; and (4) other customer statistics.

Referring to FIG. 6, Start a New Report web page 600 allows authorized users to begin new report for a selected company. Particularly, Start a New Report page 600 comprises a drop-down menu 610 of Official Company Names for the user to select from. After selecting the appropriate company, the user is prompted to select the type of report desired. Particularly, the user checks circle 620 to select the Internal Board of Directors Report, checks circle 625 to select the Annual Report, checks circle 630 to select both reports, or checks circle 635 to choose from a number of additional reports. In the illustrated embodiment, the Internal Board of Directors Report includes a list price of $495.00, the Annual Report includes a list price of $395.00 and both reports are sold for $695.00. The Start a New Report web page further includes box 640 for the Assigned Report Code, which is automatically inputted within box 640 when the authorized user selects a report.

After choosing a type of report, the authorized user is prompted to enter billing information. Specifically, box 650 is provided for the customer's name, box 660 is provided for the customer's billing address, box 670 is provided for the customers email address and box 680 is provided for other customer billing information. Of course, additional boxes for further customer billing information may be provided without departing from the scope of the present invention. For example, the creation of other types of reports may require additional standard billing inputs. According to some embodiments of the invention a text box may be provided for indicating that customers are not billed until the report is created and shipped.

Referring to FIG. 7, User Access Control web page 700 is provided for controlling access to proprietary company information. In particular, a primary account controller may add access for other authorized users. Box 710 and box 720 are provided for the name of the primary account controller and the email address of the primary account controller, respectfully. According to some embodiments of the invention, boxes 710, 720 may be filled in automatically by the system. The primary account controller may add access for a user by filling in the name and email address of the user in box 730 and box 750, respectfully, and then clicking on box 750.

With further reference to FIG. 7, the primary account controller may also remove access from selected users using drop-down menu 760. Once a user is selected, the primary account controller clicks box 770 to remove the selected user's access. Additionally, the primary controller may make changes using drop-down menu 780 to select a new primary account controller. Once selected, box 790 is clicked to make the change. According to a preferred implementation of the invention, only the current primary account controller may make such changes. Also, the new primary account controller must have current access as an authorized user. According to some embodiments of the invention, an email notice is generated automatically when access is added or removed for a user and when the primary account controller is changed.

Referring to FIG. 8, Annual Reports Plus—Data Input web page 800 is provided for entering inputs such as company name 810, financial numbers 815, financial text 820, narratives 825, and other data inputs 830. Web page 800 further comprises text 840 prompting the authorized user to enter all required inputs, as well as non-essential inputs, for the most comprehensive report. After entering the required inputs, the user clicks box 850 to generate the report. The data inputs may be printed by clicking on box 860, whereas box 870 may be clicked to save the user's inputs without generating a report.

FIG. 9 depicts Company Data Input web page 900. Once an authorized user has entered a company name into box 910, the company data information may be entered for the selected company (e.g., XYZ, Inc.). Specifically, boxes 920, 930, 940 are provided for company revenues in years 1, 2 and 3, respectfully. In addition, drop-down menu 950 is provided for selecting the primary industry for the company and box 960 is provided for entering the company's mission statement. According to some embodiments of the invention, one or more pictures 970 of the company's executives may be provided, for example using .gif files.

Referring to FIG. 10, Sample Report web page 1000 is depicted including text 1010 indicating that company revenue has increased over the past 3 years by an average of 20% per year compared to a food service industry average of only 15% per year, wherein the word, “increased”, and the value, “20%”, are based on calculations from the software program. In addition, the value, “15%”, is drawn from a database inputs and the entire paragraph is selected based on the report purpose. Additional text 1020 indicates that, “We're exceeding expectations as predicted.” Sample Report also includes a text box 1030 for the company's mission statement. Users are prompted to enter the appropriate mission statement if it is missing from box 1030. Also provided are: (1) box 1040, which may be clicked to the Start, Edit or View Your Report web page 300; (2) box 1050, which may be clicked to purchase the report; and (3) box 1060, which may be clicked to print a copy of the report.

Thus, it is seen that a system and method for Internet-based financial analysis and data processing for the creation of financial reports is provided. One skilled in the art will appreciate that the present invention can be practiced by other than the various embodiments and preferred embodiments, which are presented in this description for purposes of illustration and not of limitation, and the present invention is limited only by the claims that follow. It is noted that equivalents for the particular embodiments discussed in this description may practice the invention as well.

What is claimed is:

1. A method for Internet-based financial analysis and data processing for the creation of a financial report, the method comprising the steps of:
assembling data inputs and database inputs over the Internet;
analyzing and processing the data inputs and database inputs; and
creating a financial report;
wherein the method is implemented using a computer software program that is based on logic routines that evaluate the data and database inputs, and determine which information to incorporate into the financial report based on a predetermined purpose of the report.

2. The method of claim 1, wherein the same user data inputs can be used to create a plurality of reports having different purposes.

3. The method of claim 1, wherein the financial report comprises an Annual Report.

4. The method of claim 1, wherein the financial report comprises a plurality of sections.

5. The method of claim 4, wherein the sections include a Description of the Business section, a Property section, a Market for Equity section, a Management Discussion and Analysis section, a Financial Statements section, a Disagreements section, a Related Transactions section, and a Compliance Issues section.

6. The method of claim 1, wherein the financial report is edited and reviewed by a service provider.

7. The method of claim 1, wherein the financial report comprises an Annual Report that follows the format of the SEC 10K and 10K SB.

8. The method of claim 1, wherein the step of creating a financial report involves the use of an on-line, fully integrated narrative report editor.

9. The method of claim 1, wherein the step of creating a financial report includes the ability to create an industry-specific on-line report that only provides data for a selected company and industry.

10. A system for Internet-based financial analysis and data processing for the creation of a financial report, the system comprising the steps of:
a plurality of Internet-based data inputs and database inputs; and
a computer software program for analyzing and processing the data and database inputs;
wherein the computer software program is based on logic routines that evaluate the data and database inputs, and determine which information to incorporate into a financial report based on a predetermined purpose of the report.

11. The system of claim 10, wherein the same user data inputs can be used to create a plurality of reports having different purposes.

12. The system of claim 10, wherein the financial report comprises an Annual Report

13. The system of claim 10, wherein the financial report comprises a plurality of sections.

14. The system of claim 13, wherein the sections include a Description of the Business section, a Property section, a Market for Equity section, a Management Discussion and Analysis section, a Financial Statements section, a Disagreements section, a Related Transactions section, and a Compliance Issues section.

15. The system of claim 10, wherein the financial report is edited and reviewed by a service provider.

16. The system of claim 10, wherein the financial report comprises an Annual Report that follows the format of the SEC 10K and 10K SB.

17. The system of claim 10, wherein the step of creating a financial report involves the use of an on-line, fully integrated narrative report editor.

18. The system of claim 10, wherein the step of creating a financial report includes the ability to create an industry-specific on-line report that only provides data for a selected company and industry.

19. A method for Internet-based financial analysis and data processing for the creation of a financial report, the method comprising the steps of:
assembling data inputs and database inputs over the Internet;
analyzing and processing the data inputs and database inputs; and
creating a financial report;
wherein the financial report may be analyzed and edited by multiple users simultaneously.

20. The method of claim 19, wherein the method is implemented using a computer software program that is based on logic routines that evaluate the data and database inputs, and determine which information to incorporate into the financial report based on a predetermined purpose of the report.
